(19) United States
(12) Patent Application Publication
(10) Pub. No.: US 2024/0393652 A1
(43) Pub. Date: Nov. 28, 2024

(54) BUS BAR CONFIGURATION OF AN IGU

(71) Applicant: SAGE ELECTROCHROMICS, INC., Faribault, MN (US)

(72) Inventors: Jean-Christophe GIRON, Edina, MN (US); Bolei DI, Woodbury, MN (US); Bryan D. GREER, Northfield, MN (US)

(21) Appl. No.: 18/661,312

(22) Filed: May 10, 2024

Related U.S. Application Data
(60) Provisional application No. 63/504,165, filed on May 24, 2023.

(51) Int. Cl. G02F 1/153; E06B 9/24; G02F 1/155

(52) U.S. Cl. CPC G02F 1/1533; E06B 9/24; G02F 1/155; E06B 2009/2464

(57) ABSTRACT

An apparatus is disclosed. The apparatus can include a first conductive layer, a second conductive layer, and an active stack between the first conductive layer and the second conductive layer. The active stack can include an electrochromic material. The apparatus can further include a first bus bar electrically coupled to the first conductive layer and a second bus bar electrically coupled to the second conductive layer, where the active stack, the first bus bar, and the second bus bar are completely between the first conductive layer and the second conductive layer.

### CROSS-REFERENCE TO RELATED APPLICATION(S)

This application claims priority under 35 U.S.C. § 119 (c) to U.S. Provisional Application No. 63/504,165, entitled “BUS BAR CONFIGURATION OF AN IGU,” by Jean-Christophe GIRON et al., filed May 24, 2023, which is assigned to the current assignee hereof and incorporated herein by reference in its entirety.

### FIELD OF THE DISCLOSURE

The present disclosure is directed to electroactive devices, and more specifically to apparatuses including electrochromic devices and method of using the same.

### BACKGROUND

An electrochromic device can reduce the amount of sunlight entering a room or passenger compartment of a vehicle. Conventionally, an electrochromic device can be at a particular transmission state. For example, the electrochromic device may be set to a certain tint level (i.e., a percentage of light transmission through the electrochromic device), such as full tint (e.g., 0% transmission level), full clear (e.g., 63%+/−10% transmission level), or some tint level (or transmission level) in between the two. A glass pane may be formed with different discrete electrochromic devices, each controlled by its own pair of bus bars. The different electrochromic devices can each be set to a different tint level (i.e., % transmission state level). However, applying a voltage profile to one insulated glazing unit (IGU) to produce a tint level in the IGU does not mean that applying the same voltage profile to another IGU will produce a similar tint level. Further improvement in control regarding tinting of an electrochromic device is desired.

### BRIEF DESCRIPTION OF THE DRAWINGS

Embodiments are illustrated by way of example and are not limited in the accompanying figures.

FIG. 1A includes an illustration of a cross-sectional view of an electrochromic device with bus bars, according to one embodiment.

FIG. 1B includes an illustration of a cross-sectional view of an electrochromic device with bus bars, according to one embodiment.

FIG. 1C includes an illustration of a cross-sectional view of an electrochromic device with bus bars, according to one embodiment.

FIG. 2 includes an illustration of an electrochromic device, according to one embodiment.

FIGS. 3A-3C include illustrations of top views of the electrochromic device of FIG. 2, according to various embodiments.

FIGS. 4A-4J include illustrations of top views of an electrochromic device, according to various embodiments.

FIGS. 5A-5B include illustrations of top views of an electrochromic device, according to various embodiments.

FIG. 6 includes an illustration of a cross-sectional of an insulated glass unit (IGU).

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

When referring to variables, the term “steady state” is intended to mean that an operating variable is substantially constant when averaged over 10 seconds, even though the operating variable may be changed during a transient state. For example, when in steady state, an operating variable may be maintained within 10%, within 5%, or within 0.9% of an average for the operating variable for a particular mode of operation for a particular device. Variations may be due to imperfections in an apparatus or supporting equipment, such as noise transmitted along voltage lines, switching transistors within a control device, operating other components within an apparatus, or other similar effects. Still further, a variable may be changed for a microsecond each second, so that a variable, such as voltage or current, may be read; or one or more of the voltage supply terminals may alternate between two different voltages (e.g., V1 and V2) at a frequency of 1 Hz or greater. Thus, an apparatus may be at steady state even with such variations due to imperfections or when reading operating parameters. When changing between modes of operation, one or more of the operating variables may be in a transient state. Examples of such variables can include voltages at particular locations within an electrochromic device or current flowing through the electrochromic device.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

Many different patterns for the transmission states of an electrochromic device can be achieved by the proper selection of bus bar location, the number of voltage supply terminals coupled to each bus bar, locations of voltage supply terminals along the bus bars, or any combination thereof. Varying locations of the bus bars can provide voltages that can range from fully clear (highest transmission or fully bleached) to fully tinted (lowest transmission state), or anything in between. The electrochromic device can be used as part of a window for a building or a vehicle or other applications that can benefit from a controllable tinting, such as partitions that separate living spaces or office spaces. The electrochromic device can be used within an apparatus. The apparatus can further include an energy source, an input/output unit, and a control device that controls the electrochromic device. Components within the apparatus may be located near or remotely from the electrochromic device. In an embodiment, one or more of such components may be integrated with environmental controls within a building.

An electrochromic device can operate with voltages on bus bars being in a range of 0 V to 50 V. In one embodiment, the voltages can be between 0 V and 25 V. In another embodiment, the voltages can be between 0 V and 10 V. In yet another embodiment, the voltages can be between 0 V and 3 V. Such description is used to simplify concepts as described herein. Other voltages may be used with the electrochromic device, such as if the composition or thicknesses of layers within an electrochromic stack are changed. The voltages on bus bars may both be positive (0.1 V to 50 V), both negative (−50 V to −0.1 V), or a combination of negative and positive voltages (−1 V to 2 V), as the voltage difference between bus bars are more important than the actual voltages. Furthermore, the voltage difference between the bus bars may be less than or greater than 50 V. Embodiments described herein are exemplary and not intended to limit the scope of the appended claims.

When controlling the tint profile of an electrochromic device (ECD) in an insulated glass unit (IGU), a voltage profile can be applied to the bus bars of the ECD to produce a desired tint level. A tint profile can be fully clear (highest transmission or fully bleached) to fully tinted (lowest transmission state), or anything in between, and can also be a substantially uniform across all of the area of the ECD. However, constant development is needed to ensure that the electrochromic device continues to switch from one tint profile to another tint profile with relative quickness or speed, that the process is simplistic for an end user, and that the tint profiles consume less energy than has been seen before.

The current disclosure provides an IGU system with an electrochromic device that alleviates or at least minimizes the issues associated with varied performance characteristics.

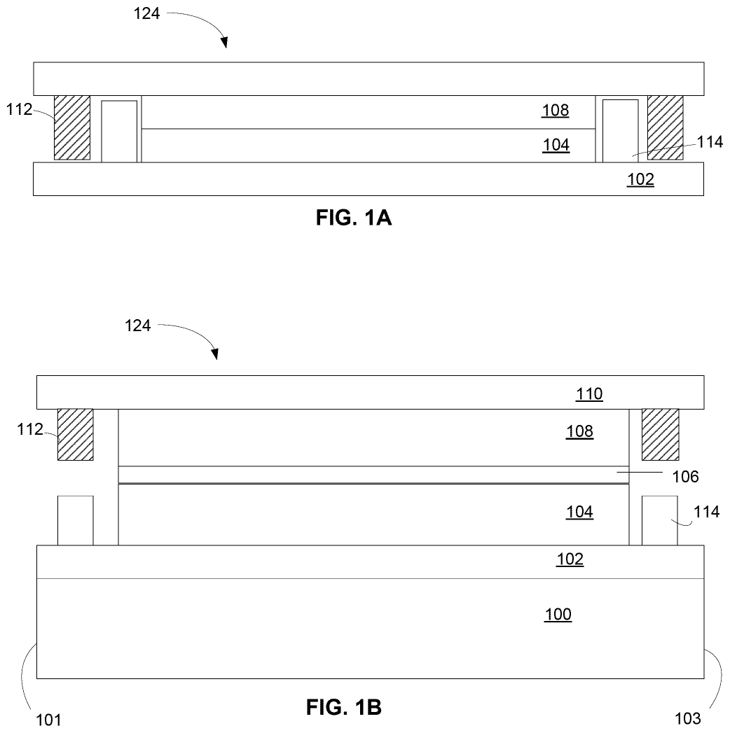

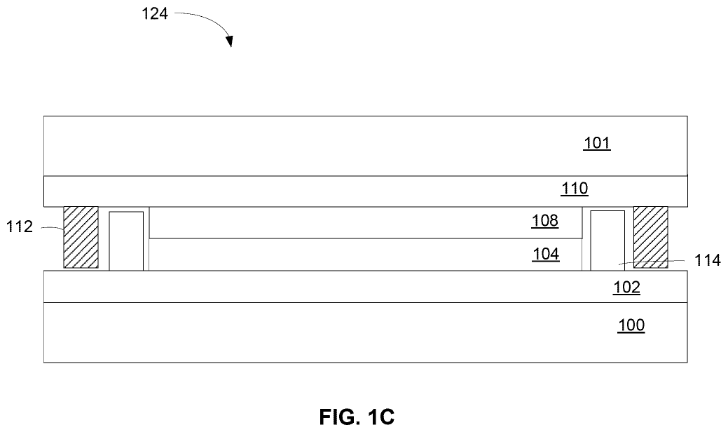

FIGS. 1A-1C include illustrations of a cross section of an electrochromic device 124 with a double bus bar design, according to several embodiments. Many various shaped IGUs and thus various shaped ECDs 124 are disclosed in the U.S. Provisional Patent Application No. 62/786,603 which is incorporated herein in its entirety by this reference and each of the IGUs, substrates, and ECDs, disclosed in this referenced provisional patent application can benefit from the aspects of this disclosure. As seen in FIG. 1B, the electrochromic device 124 can include a substrate 100, a first transparent conductive layer 102, a cathodic electrochemical layer 104, an ion conducting layer 106, a counter electrode layer 108, a second transparent conductive layer 110, a first bus bar 112, and a second bus bar 114. In one embodiment, the electrochromic device 124 can include a first transparent conductive layer 102, a cathodic electrochemical layer 104, an ion conducting layer 106, a counter electrode layer 108, a second transparent conductive layer 110, a first bus bar 112, and a second bus bar 114, as seen in FIG. 1A.

In another embodiment, the electrochromic device 124 can include a first substrate 100, a second substrate 101, a first transparent conductive layer 102, a cathodic electrochemical layer 104, an ion conducting layer 106, a counter electrode layer 108, a second transparent conductive layer 110, a first bus bar 112, and a second bus bar 114, as seen in FIG. 1C. In another embodiment, the electrochromic device 124 can include a first substrate 100, a second substrate 101, a first transparent conductive layer 102, a second transparent conductive layer 110, an electrochromic material between the first transparent conductive layer 102 and the second transparent conductive layer 110, a first bus bar 112, and a second bus bar 114.

In one embodiment, the ion conducting layer 106 can be between the cathodic electrochemical layer 104 and counter electrode layer 108. In another embodiment, the ion conducting layer 106, cathodic electrochemical layer 104, and counter electrode layer 108 can be between the first transparent conductive layer 102 and the second transparent conductive layer 110. In a particular embodiment, the first bus bar 112 and the second bus bar 114 can be between the first transparent conductive layer 102 and the second transparent conductive layer 110.

The substrate 100, 101 can include a glass substrate, a sapphire substrate, an aluminum oxynitride substrate, a spinel substrate, or a transparent polymer. In a particular embodiment, the substrate 100 can be float glass or a borosilicate glass and have a thickness in a range of 0.025 mm to 4 mm thick. In another particular embodiment, the substrate 100 can include ultra-thin glass that is a mineral glass having a thickness in a range of 10 microns to 300 microns. In one embodiment, the first transparent conductive layer 102 can be deposited on the substrate. In another embodiment, the first conductive layer 102, the second conductive layer 110, the cathodic electrochemical layer 104, the anodic electrochemical layer 108, the first bus bar 112 and the second bus bar 114 can between the first substrate 100 and the second substrate 101. In another embodiment, the active stack can include an electrochromic material. In one embodiment, the electrochromic material can include various layers, such as the cathodic electrochemical layer 104, the ion conductive layer 106, and the counter electrode layer 108.

The cathodic electrochemical layer 104 and the anodic electrochemical layer 108 can be electrode layers. In one embodiment, the cathodic electrochemical layer 104 can be an electrochromic layer. In another embodiment, the anodic electrochemical layer 108 can be a counter electrode layer. The cathodic electrochemical layer 104 can include an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, or any combination thereof and Li, Na, H, or another ion or combination thereof and have a thickness in a range of 20 nm to 2000 nm. The counter electrode layer 108 can include any of the materials listed with respect to the cathodic electrochemical layer 104 and may further include nickel oxide (NiO, Ni₂O₃, or combination of the two) or iridium oxide or any combination thereof, and Li, Na, H, or another ion or any combination thereof and have a thickness in a range of 20 nm to 1000 nm.

The ion conductive layer 106 (sometimes called an electrolyte layer) can be optional, and can have a thickness in a range of 1 nm to 1000 nm in case of an inorganic ion conductor or 5 microns to 1000 microns in case of an organic ion conductor. The ion conductive layer 106 can include a silicate with or without lithium, aluminum, zirconium, phosphorus, boron; a borate with or without lithium; a tantalum oxide with or without lithium; a lanthanide-based material with or without lithium; another lithium-based ceramic material particularly LixMOyNz where M is one or a combination of transition metals or the like.

The first transparent conductive layer 102 and second transparent conductive layer 110 can include a conductive metal oxide or a conductive polymer. Examples can include an indium oxide, tin oxide or a zinc oxide, either of which can doped with a trivalent element, such as Sn, Sb, Al, Ga, In, or the like, or a sulfonated polymer, such as polyaniline, polypyrrole, poly(3,4-ethylenedioxythiophene), or the like or one or several metal layer(s) or a metal mesh or a nanowire mesh or graphene or carbon nanotubes or a combination thereof. The transparent conductive layers 102 and 110 can have the same or different compositions.

The first bus bar 112 can be electrically connected to the second transparent conductive layer 110. The second bus bar 114 can be electrically coupled to the first transparent conductive layer 102. In one embodiment, the first bus bar 112 and the second bus bar 114 are on the perimeter of and/or separated from the ion conducting layer 106, cathodic electrochemical layer 104, and counter electrode layer 108. In a particular embodiment, the first bus bar 112 and the second bus bar 114 are electrically isolated from one another. In one embodiment, an insulating tape can be used to electrically isolate the first bus bar 112 from the second bus bar 114.

In the embodiment of FIG. 1A, the first bus bar 112 can be closer to the edge of the electrochromic device 124, and in particular to an outer edge of the substrate 100, than the second bus bar 114. In one embodiment, the first bus bar 112 can be exterior to the second bus bar 114. In another embodiment, the first bus bar 112 can be lateral to the second bus bar 114. In one embodiment, the first bus bar 112 can be lateral to and overlap the second bus bar 114 without touching the second bus bar 114. In one embodiment, the combined thickness of the cathodic electrochemical layer 104, the counter electrode layer 108, and the ion conducting layer 106 can be less than the combined thickness of the first bus bar 112 and the second bus bar 114. The substrate 100 can have a first edge 101 and a second edge 103. The first edge 101 can be opposite the second edge 103. In an embodiment, the first bus bar 112 can be closer to the first edge 101 and the second edge 103 than the second bus bar 114. In another embodiment, the second bus bar 114 can be closer to the outer edge of the electrochromic device 124 than the first bus bar 112; that is to say the first bus bar 112 can be interior to the second bus bar 114. In such an embodiment, the second bus bar 114 is closer to the first edge 101 and the second edge 103 than the first bus bar 112.

In yet another embodiment, the first bus bar 112 and the second bus bar 114 can overlap one another, as seen in FIG. 1B. In one embodiment, the first bus bar 112 and the second bus bar 11 can be one on top of each other on the same plane without touching, as seen in FIG. 1B. For instance, the first bus bar 112 and the second bus bar 114 can be overlapping and equidistant to an edge of the active stack. Such an embodiment can be possible when the combined thicknesses of the ion conducting layer 106, cathodic electrochemical layer 104, and counter electrode layer 108 is greater than the combined thicknesses of the first bus bar 112 and the second bus bar 114. In one embodiment, the thickness of cathodic electrochemical layer 104 can be greater than the thickness of the counter electrode layer 108 and the thickness of the ion conducting layer 106 such that the combined thickness of the aforementioned layers is greater than the combined thickness of the first bus bar 112 and the second bus bar 114. In another embodiment, the thickness of cathodic electrochemical layer 104 can be equal to the thickness of the counter electrode layer 108 and the thickness of the ion conducting layer 106 such that the combined thickness of the aforementioned layers is greater than the combined thickness of the first bus bar 112 and the second bus bar 114.

In another embodiment, the thickness of cathodic electrochemical layer 104 can be less than the thickness of the counter electrode layer 108 and the thickness of the ion conducting layer 106 such that the combined thickness of the aforementioned layers is greater than the combined thickness of the first bus bar 112 and the second bus bar 114. In such an embodiment, the first bus bar 112 can be over the second bus bar 114 without touching the second bus bar 114. In one embodiment, the combined thicknesses of the ion conducting layer 106, cathodic electrochemical layer 104, and counter electrode layer 108 can be at least two times greater than the combined thicknesses of the first bus bar 112 and the second bus bar 114. In one embodiment, the combined thicknesses of the ion conducting layer 106, cathodic electrochemical layer 104, and counter electrode layer 108 can be at least 1.5 times greater, such as 2.5 times greater, or 3 times greater than the combined thicknesses of the first bus bar 112 and the second bus bar 114. The first bus bar 112 can be about equidistant to the first edge 101 and the second edge 103 of the substrate as the second bus bar 114. In such an embodiment, the first bus bar 112 and the second bus bar 114 can be mirror images of one another. The first bus bar 112 can be electrically coupled to the second transparent conductive layer 110 and the second bus bar 114 can be electrically coupled to the first transparent conductive layer 102 while also physically being between the first transparent conductive layer 102 and the second transparent conductive layer 110. The first bus bar 112 can be on two or more sides of the second transparent conductive layer 110. The second bus bar 114 can be on two or more sides of the first transparent conductive layer 102. In one embodiment, the first bus bar 112 can be along two or more edges of the second transparent conductive layer 110. In another embodiment, the second bus bar 114 can be along two or more edges of the first transparent conductive layer 102. As will be seen and discussed in the various embodiments of the present disclosure, when viewing the electrochromic device from the top, if the first bus bar 112 and the second bus bar 114 are overlapping, not all of the pieces of the bus bar from either the first or second bus bar may be seen. As such, the discussions and illustrations have been chosen to show the pieces of the bus bars, but it should be understood that any of the foregoing configurations could be in such a way as to have the first bus bar 112 overlapping the second bus bar 114.

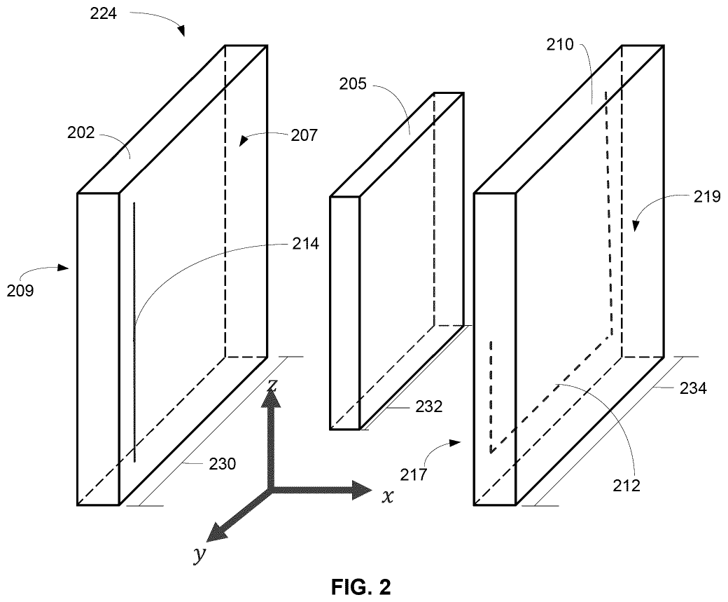

FIG. 2 includes an illustration of an electrochromic device 224, according to one embodiment. The electrochromic device 224, in FIG. 2 has been separated to further illustrate the location of a first bus bar and a second bus bar relative to each other as well as to the electrochromic stack. The electrochromic device 224 can include a first transparent conductive layer 202, a second transparent conductive layer 210, an electrochromic stack 205, a first bus bar 212, and a second bus bar 214. While not shown in FIG. 2, the electrochromic device 224 can also include additional elements such as a substrate. In one embodiment, the electrochromic stack 205 can include a cathodic electrochemical layer 204, a counter electrode layer 208, and an ion conducting layer 206 between the cathodic electrochemical layer 204 and the counter electrode layer 208. The electrochromic stack 205 can be between the first transparent conductive layer 202 and the second transparent conductive layer 210. In one embodiment, a length 232 of the electrochromic stack 205 can be less than a length 230 of the first transparent conductive layer 202. In another embodiment, a length 232 of the electrochromic stack 205 can be less than a length 234 of the second transparent conductive layer 210.

The first transparent conductive layer 202 can include a first side 207 and a second side 209 opposite the first side 207. In one embodiment, the second bus bar 214 is adjacent to the first side 207 of the first transparent conductive layer 202. In another embodiment, the second bus bar 214 can be closer to the first side 207 than the second side 209 of the first transparent conductive layer 202. In another embodiment, the second bus bar 214 can be on the first side 207 of the first transparent conductive layer 202. In one embodiment, and as described in more detail below, the second bus bar 214 can include at least two continuous segments that span one or more edges of the first side 207 of the first transparent conductive layer 202.

The second transparent conductive layer 210 can include a first side 217 and a second side 219 opposite the first side 217. In one embodiment, the first bus bar 212 can be closer to the first side 217 than to the second side 219 of the second transparent conductive layer 210. The first bus bar 212 can include at least two segments and can be closer to the second transparent conductive layer 210 than the first transparent conductive layer 202. In one embodiment, the first bus bar 212 can include three or more segments that span at least three edges of the second transparent conductive layer 210. In one embodiment, the first side 217 of the second transparent conductive layer 210 can face the first side 207 of the first transparent conductive layer 207. In one embodiment, the first side 217 of the second transparent conductive layer 210 can face the first side 207 of the first transparent conductive layer 202.

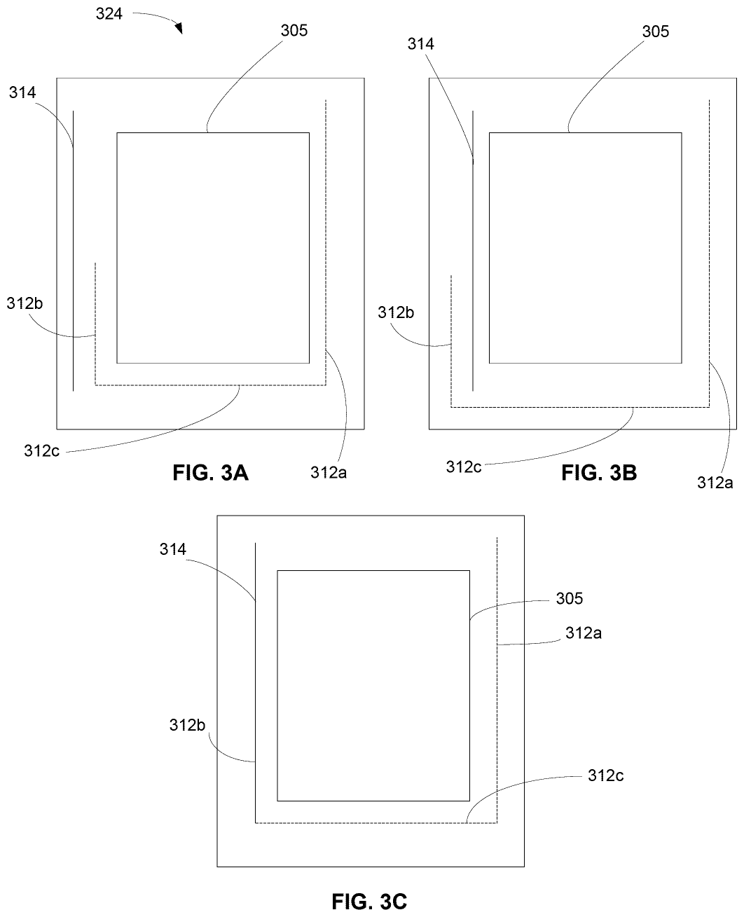

FIGS. 3A-3C include illustrations of top views of the electrochromic device of FIG. 2, according to various embodiments. Each of the embodiments of FIG. 3A-3C are exemplary as the combinations possible with respect to the configurations of the bus bars of any of the configurations described above and below. That is to say, depending on the thickness of the electrochromic stack, as exemplified in FIGS. 1A and 1B, various configurations of bus bars can be used. FIG. 3A is a top view of the electrochromic device of FIG. 2, according to one embodiment. The electrochromic device 324 can include a first bus bar 312, a second bus bar 314, and an electrochromic stack 305.

The electrochromic stack 305 can include an electrochromic layer, an ion conducting layer, and a counter electrode layer. The first bus bar 312 and the second bus bar 314 can be on different transparent conductive layers, as described above. The first bus bar 312 can include more than one segment along at least two edges of the electrochromic device 324. In one embodiment, the first bus bar 312 can have a first segment 312a, a second segment 312b, and a third segment 312c between the first segment 312a and the second segment 312b. The first segment 312a can be parallel to the second segment 312b. The third segment 312c can be orthogonal to the first segment 312a. The second bus bar 314 can be parallel to the first segment 312a of the first bus bar 312. In one embodiment, the first segment 312a, the second segment 312b, and the third segment 312c can be continuous and run along three edges of the electrochromic device. In one embodiment, such as seen in FIG. 3A, the first segment 312a, the second segment 312b, and the third segment 312c can be closer to the electrochromic stack 305 than the second bus bar 314. In one embodiment, such as seen in FIG. 3B, the second bus bar 314 can be closer to the electrochromic stack 305 than the second segment 312b. In one embodiment, as seen in FIG. 3C, the second bus bar 314 can be equidistant to the electrochromic stack 305 as the second segment 312b. In the embodiment of FIG. 3C, the thickness of the electrochromic stack 305 is greater than the combined thickness of the first bus bar 312 and the second bus bar 314. As such, the first bus bar 312 and the second bus bar 314 can be equidistant to the electrochromic stack 305. As exemplified in FIGS. 3A-3C the first bus bar 312 and the second bus bar 314 can have multiple configurations with respect to the electrochromic stack 305.

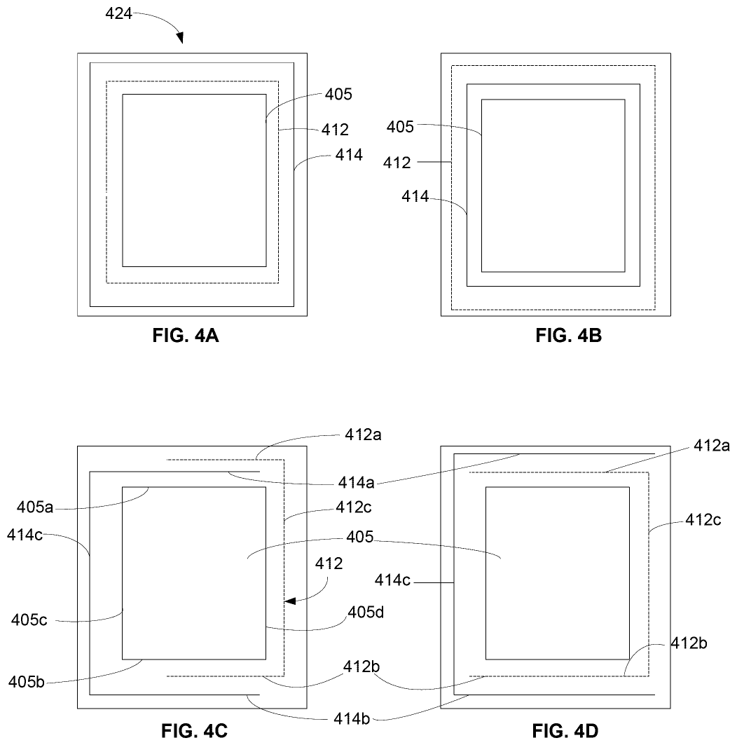

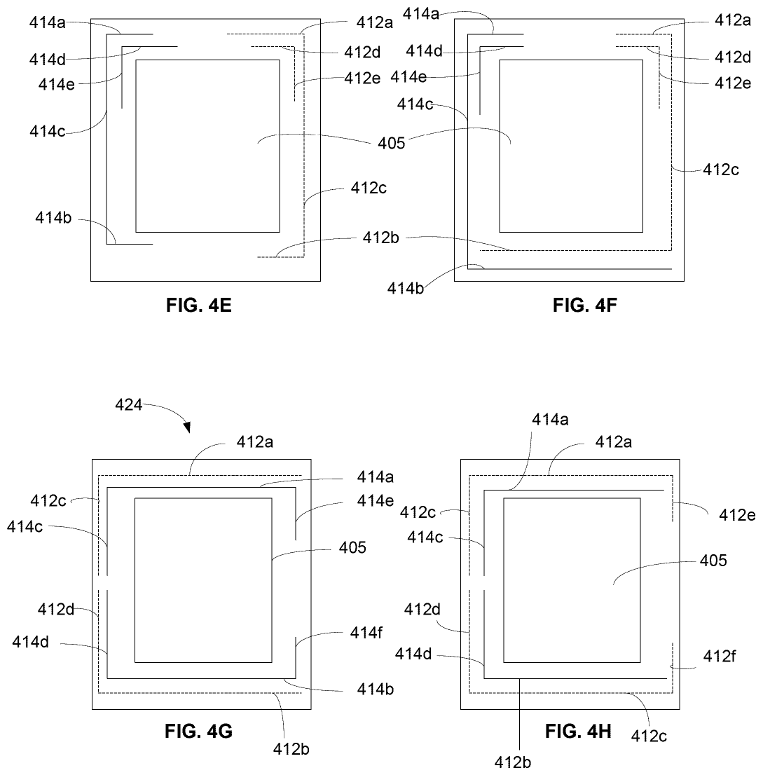

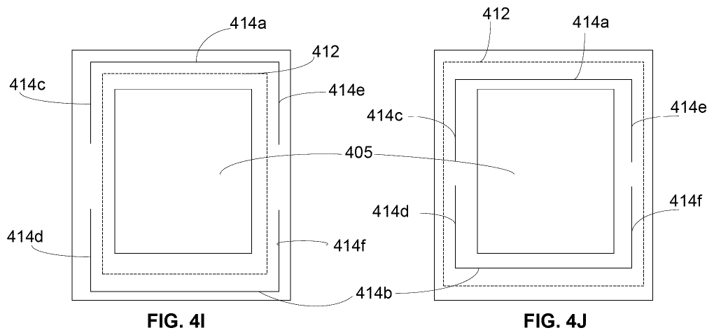

FIGS. 4A-4J are illustrations of a top view of an electrochromic stack, according to various embodiments. The electrochromic device 424 can be similar to the electrochromic device 324, 224, and 124. The electrochromic device 424 can include a first bus bar 412 and a second bus bar 414.

The first bus bar 412 can include two or more segments. In another embodiment, the first bus bar 412 can include three or more segments. In a particular embodiment, the first bus bar 412 can include at least 4 segments. The two or more segments of the first bus bar 412 can be continuous. In one embodiment, as seen in FIG. 4A, the first bus bar 412 can be closer to the electrochromic stack 405 than the second bus bar 414. The first bus bar 412 can include four continuous segments that are adjacent to all edges of the electrochromic device 424. In one embodiment, the first bus bar 412 can be interior to the second bus bar 414. In one embodiment, all segments of the first bus bar 412 can be closer to the electrochromic stack 405 than any segment of the second bus bar 414. In one embodiment, some segments of the first bus bar 412 can be closer to a first edge of the electrochromic stack 405 than segments of the second bus bar 414 while other segments of the first bus bar 412 can be farther from a first edge of the electrochromic stack 405 than segments of the second bus bar 414.

In one embodiment, the second bus bar 414 can include one or more segments. In another embodiment, the second bus bar 414 can include three or more segments. In a particular embodiment, the second bus bar 414 can include at least 4 segments. The two or more segments of the second bus bar 414 can be continuous. In one embodiment, as seen in FIG. 4B, the second bus bar 414 can be closer to the electrochromic stack 405 than the first bus bar 412. The second bus bar 414 can include 4 segments that are adjacent to all sides of the electrochromic device 424. In one embodiment, all segments of the second bus bar 414 can be closer to the electrochromic stack 405 than any segment of the first bus bar 412.

In one embodiment, the first bus bar 412 can include three continuous segments, where a first segment 412a that can be parallel to a second segment 412b, and a third segment 412c is orthogonal to and in between the first segment 412a and the second segment 412b. The second bus bar 414 can include a first segment 414a that can be parallel to a second segment 414b and a third segment 414c that can be orthogonal to and in between the first segment 414a and the second segment 414b. In one embodiment, the electrochromic stack 405 can have a first side 405a opposite to and parallel to a second side 405b and a third side 405c opposite to and parallel to a fourth side 405d. The first side 405a can be orthogonal to the third side 405c. In one embodiment, as seen in FIG. 4C, one segment from the second bus bar 414 can be closer to a first side 405a of the electrochromic stack 405 than the first bus bar 412 and one segment from the first bus bar 412 can be closer to a second side 405b of the electrochromic stack 405 than the second bus bar 414. In one embodiment, the third segment 412c and the second segment 412b can be closer to the second side 405b and the fourth side 405d than the second bus bar 414. In one embodiment, the first segment 414a and the third segment 414c of the second bus bar 414 can be closer to the third side 405c and the first side 405a of the electrochromic stack 405 than the first bus bar 412. In another embodiment, the first bus bar 412 can include at least two segments that overlap with at least two segments of the second bus bar 414.

In another embodiment, as seen in FIG. 4D, the first bus bar 412 can have at least three segments and the at least three segments can be closer to the electrochromic stack than the second bus bar 414. In one embodiment, as seen in FIG. 4D, the first segment 414a of the second bus bar 414 and the second segment 414b of the second bus bar 414 can be closer to an outside edge of the electrochromic device than the first segment 412a and the second segment 412b of the first bus bar 412.

The first bus bar 412 and the second bus bar 414 can each have a segment that is discontinuous and a segment that is continuous, as seen in FIGS. 4E and 4F. In one embodiment, the first bus bar 412 can have a first segment 412a, a second segment 412b, a third segment 412c, a fourth segment 412d, and a fifth segment 412e. The first segment 412a can be parallel to the second segment 412b. The third segment 412c can be between the first segment 412a and the second segment 412b. The fourth segment 412d can be continuous with the fifth segment 412c but discontinuous from the first segment 412a. In one embodiment, the fourth segment 412d is parallel to the first segment 412a and the fifth segment 412e can be parallel to the third segment 412c. The third segment 412c can be orthogonal to the first segment 412a. The segments of the first bus bar 412 can have varying lengths. In one embodiment, the fourth segment 412d can be closer to the electrochromic stack 405 than the first segment 412a.

In one embodiment, the second bus bar 414 can have a first segment 414a, a second segment 414b, a third segment 414c, a fourth segment 414d, and a fifth segment 414e. The first segment 414a can be parallel to the second segment 414b. The third segment 414c can be between the first segment 414a and the second segment 414b. The fourth segment 414d can be continuous with the fifth segment 414e but discontinuous from the first segment 414a. In one embodiment, the fourth segment 414d is parallel to the first segment 414a and the fifth segment 414e can be parallel to the third segment 414c. The third segment 414c can be orthogonal to the first segment 414a. The segments of the second bus bar 414 can have varying lengths. In one embodiment, the fourth segment 414d can be closer to the electrochromic stack 405 than the first segment 414a.

In one embodiment, and as seen in FIG. 4F, the second segment 412b of the first bus bar 412 can be closer to the electrochromic stack 405 than the second segment 414b of the second bus bar 414. In another embodiment, and as seen in FIG. 4E, the second segment 414b of the second bus bar 414 can be closer to the electrochromic stack 405 than the second segment 412b of the first bus bar 412.

In one embodiment, the first bus bar 412 can include two or more segments. In one embodiment, the first bus bar 412 can include three or more segments. The first bus bar 412 can include a first segment 412a, a second segment 412b, a third segment 412c, and a fourth segment 412d. In one embodiment, the first segment 412a and the second segment 412b can be parallel. In one embodiment, the first segment 412a can be orthogonal to the third segment 412c. In one embodiment, the second segment 412b can be orthogonal to the fourth segment 412d. In one embodiment, the first segment 412a can be continuous with the third segment 412c. In another embodiment, the second segment 412b can be continuous with the fourth segment 412d. In one embodiment, the third segment 412c can be discontinuous from the fourth segment 412d. That is to say, there may be a gap between the third segment 412c and the fourth segment 412d. In one embodiment, as seen in FIG. 4G, the first bus bar can be adjacent to at least three edges of the electrochromic device 424. In one embodiment, the second bus bar 414 can be closer to the electrochromic stack 405 than the first bus bar 412. In another embodiment, as seen in FIG. 4I, the first bus bar 412 can be closer to the electrochromic stack 405 than the second bus bar 414.

In one embodiment, the first bus bar 412 can be completely continuous while the second bus bar 414 can be discontinuous. In another embodiment, the second bus bar 414 can be completely continuous while the first bus bar 412 can be discontinuous. In one embodiment, the first bus bar 412 can be completely continuous and be adjacent to at least four edges of the electrochromic device 424. In one embodiment, the first bus bar 412 can be completely continuous, be adjacent to at least four edges of the electrochromic device 424 and be farther from the electrochromic stack 405 than the second bus bar 414, as seen in FIG. 4J. In one embodiment, the second bus bar 414 can include at least four segments.

In one embodiment, the second bus bar 414 can include two or more segments. In one embodiment, the second bus bar 414 can include three or more segments. The second bus bar 414 can include a first segment 414a, a second segment 414b, a third segment 414c, a fourth segment 414d, a fifth segment 414c, and a sixth segment 414f. In one embodiment, the first segment 414a and the second segment 414b can be parallel. In one embodiment, the first segment 414a can be orthogonal to the third segment 414c. In one embodiment, the second segment 414b can be orthogonal to the fourth segment 414d. In one embodiment, the first segment 414a can be continuous with the third segment 414c and the fifth segment 414c. In another embodiment, the second segment 414b can be continuous with the fourth segment 414d and the sixth segment 414f. In one embodiment, the third segment 414c can be discontinuous from the fourth segment 414d. That is to say, there may be a gap between the third segment 414c and the fourth segment 414d. In one embodiment, as seen in FIG. 4G, the second bus bar 414 can be adjacent to at least four edges of the electrochromic device 424. The second bus bar 414 can be adjacent to at least three edges of the electrochromic device 424 where the second bus bar 414 can have at least 4 segments, as seen in FIG. 4H. In a particular embodiment, the second bus bar 414 can be adjacent to at least four edges of the electrochromic device 424 where the second bus bar 414 can have at least 6 segments, as seen in FIG. 4G. In one embodiment, the second bus bar 414 can be closer to the electrochromic stack 405 than the first bus bar 412. In another embodiment, the second bus bar 414 can include at least five segments. In another embodiment, the second bus bar 414 can include at least six segments. In one embodiment, the second bus bar 414 can be adjacent to at least three edges of the electrochromic device 424. In one embodiment, the second bus bar 414 can be adjacent to at least four edges of the electrochromic device 424.

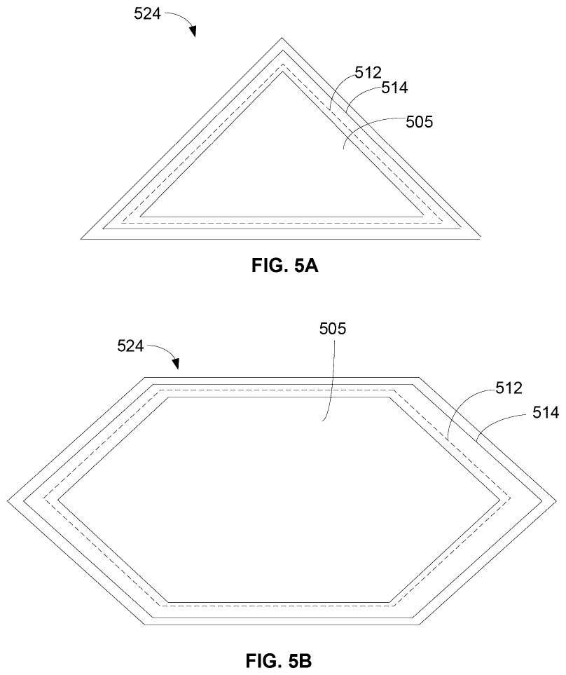

FIGS. 5A-5B include illustrations of top views of an electrochromic device, according to various embodiments. The bus bar designs, with respect to a first bus bar, and a second bus bar as seen in FIGS. 4A-4J can be used in various shaped electrochromic devices, such as seen in FIGS. 5A and 5B. Without wishing to be repetitive, a first bus bar 512 can be similar to the first bus bar 412. The first bus bar 512 can include one or more segments. The one or more segments of the first bus bar 512 can be discontinuous or continuous as seen in FIGS. 5A and 5B. The second bus bar 514 can include one or more segments. The one or more segments of the second bus bar 514 can be discontinuous or continuous as seen in FIGS. 5A and 5B. In one embodiment, the first bus bar 512 can be closer to all the edges of the electrochromic device 524 than the second bus bar 514. In another embodiment, the second bus bar 514 can be closer to all edges of the electrochromic device 524 than the first bus bar 512. The electrochromic device can be of varying shapes, such as polygonal, rectangular, square, circular, triangular, hexagonal, and trapezoidal.

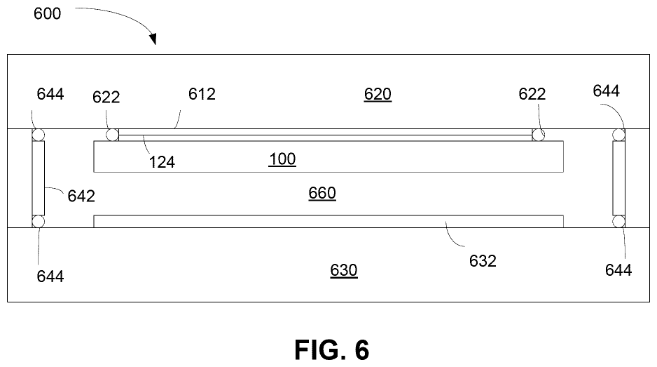

The electrochromic devices described above can be further processed in an insulated glazing unit, as the one described in FIG. 6. Additionally, the electrochromic devices described above can be further processed in a triple glazing unit, a laminate, or other device. FIG. 6 includes an illustration of a cross-sectional of an insulated glass unit (IGU) 600. The insulated glass unit (IGU) 600 can include a substrate 100 and the electrochromic device 124 as illustrated in FIGS. 1A-1C, 2, 3A-3C and 4A-4F. The IGU 600 can further include a counter substrate 620 and a solar control film 612 disposed between the electrochromic device 124 and the counter substrate 620. A seal 622 is disposed between the substrate 100 and the counter substrate 520 and around the electrochromic device 124. The seal 622 can include a polymer, such as polyisobutylene. The counter substrate 620 is coupled to a pane 630. Each of the counter substrates 620 and pane 630 can be a toughened or a tempered glass and have a thickness in a range of 2 mm to 9 mm. A low-emissivity layer 632 can be disposed along an inner surface of the pane 630. The counter substrate 620 and pane 630 can be spaced apart by a spacer bar 642 that surrounds the substrate 100 and electrochromic device 124. The spacer bar 642 is coupled to the counter substrate 620 and pane 630 via seals 644. The seals 644 can be a polymer, such as polyisobutylene. The seals 644 can have the same or different composition as compared to the seal 622. An adhesive joint (not shown) is designed to hold the counter substrate 620 and the pane 630 together and is provided along the entire circumference of the edges of the counter substrate 620 and the pane 630. An internal space 660 of the IGU 600 may include a relatively inert gas, such as a noble gas or dry air. In another embodiment, the internal space 660 may be evacuated.

The IGU can include an energy source, a control device, and an input/output (I/O) unit. The energy source can provide energy to the electrochromic device 124 via the control device. In an embodiment, the energy source may include a photovoltaic cell, a battery, another suitable energy source, or any combination thereof. The control device can be coupled to the electrochromic device and the energy source. The control device can include logic to control the operation of the electrochromic device. The logic for the control device can be in the form of hardware, software, or firmware. In an embodiment, the logic may be stored in a field programmable gate array (FPGA), an application-specific integrated circuit (ASIC), or another persistent memory. In an embodiment, the control device may include a processor that can execute instructions stored in memory within the control device or received from an external source. The I/O unit can be coupled to the control device. The I/O unit can provide information from sensors, such as light, motion, temperature, another suitable parameter, or any combination thereof. The I/O unit may provide information regarding the electrochromic device 124, the energy source, or control device to another portion of the apparatus or to another destination outside the apparatus.

It should be understood that any of the preceding embodiments can yield tint profiles that can be fully clear (highest transmission or fully bleached) to fully tinted (lowest transmission state), or anything in between. The tint profile can also be a substantially uniform transmission state across all of the area of the electrochromic device 124, 424, a continuously graded transmission state across all of the area of the electrochromic device 124, 424, or with a combination of a portion with a substantially uniform transmission state and another portion with a continuously graded transmission state.

Many different aspects and embodiments are possible. Some of those aspects and embodiments are described below. Exemplary embodiments may be in accordance with any one or more of the ones as listed below.

### EMBODIMENTS

Embodiment 1. An apparatus can include a first conductive layer, a second conductive layer, and an active stack. The active stack can include an anodic electrochemical layer between the first conductive layer and the second conductive layer and a cathodic electrochemical layer between the first conductive layer and the second conductive layer. The apparatus can further include a first bus bar electrically coupled to the first conductive layer and a second bus bar electrically coupled to the second conductive layer, where the active stack, the first bus bar, and the second bus bar are completely between the first conductive layer and the second conductive layer.

Embodiment 2. The apparatus of embodiment 1, further including a first substrate, where the active stack is between the second conductive layer and the substrate.

Embodiment 3. The apparatus of embodiment 2, further including a second substrate, where the first conductive layer and the second conductive layer are between the first substrate and the second substrate.

Embodiment 4. The apparatus of embodiment 1, where the first bus bar can include one or more segments that are adjacent to the active stack.

Embodiment 5. The apparatus of embodiment 4, where the second bus bar can include one or more segments that are adjacent to the active stack.

Embodiment 6. The apparatus of embodiment 5, where the first bus bar is closer to an edge of the active stack than the second bus bar.

Embodiment 7. The apparatus of embodiment 5, where the second bus bar is closer to an edge of the active stack than the first bus bar.

Embodiment 8. The apparatus of embodiment 5, where the first bus bar is about equidistant from an edge of the active stack as the second bus bar.

Embodiment 9. The apparatus of embodiment 5, where the one or more segments of the second bus bar are continuous.

Embodiment 10. The apparatus of embodiment 4, where the one or more segments of the first bus bar are continuous.

Embodiment 11. The apparatus of embodiment 1, further including an ion conducting layer between the anodic electrochemical layer and the cathodic electrochemical layer.

Embodiment 12. The apparatus of embodiment 1, where the active stack is smaller than the first conductive layer.

Embodiment 13. The apparatus of embodiment 1, where a length of the active stack is less than a length of the second conductive layer.

Embodiment 14. The apparatus of embodiment 8, where a combined thickness of the anodic electrochemical layer, the cathodic electrochemical layer, and the ion conducting layer is greater than a combined thickness of the first bus bar and the second bus bar.

Embodiment 15. The apparatus of embodiment 7, where a combined thickness of the anodic electrochemical layer, the cathodic electrochemical layer, and the ion conducting layer is less than a combined thickness of the first bus bar and the second bus bar.

Embodiment 16. An apparatus including: a first conductive layer including a first side and a second side, where the first side is opposite the second side, a second conductive layer including a first side and a second side, where the first side is opposite the second side, and where the first side of the first conductive layer faces the first side of the second conductive layer, and an active stack. The active stack including an anodic electrochemical layer between the first conductive layer and the second conductive layer; and a cathodic electrochemical layer between the first conductive layer and the second conductive layer. The apparatus can further include a first bus bar electrically coupled to the first conductive layer, where the first bus bar is adjacent to the first side of the first conductive layer and a second bus bar electrically coupled to the second conductive layer, where the second bus bar is adjacent to the first side of the second conductive layer.

Embodiment 17. The apparatus of embodiment 16, where the active stack can include a first side, a second side opposite the first side, a third side generally non-parallel to the first side, and a fourth side parallel to and opposite the third side.

Embodiment 18. The apparatus of embodiment 17, where the second bus bar can include at least two segments and the first bus bar can include at least two segments.

Embodiment 19. The apparatus of embodiment 17, where the at least two segments of the second bus bar are continuous.

Embodiment 20. The apparatus of embodiment 17, where the at least two segments of the first bus bar are continuous.

Embodiment 21. The apparatus of embodiment 18, where the second bus bar can include no more than six segments and the first bus bar can include no more than six segments.

Embodiment 22. The apparatus of embodiment 18, where at least one segment of the at least two segments of the second bus bar is closer to the first side of the active stack than any of the at least two segments of the first bus bar and where at least one segment of the at least two segments of the first bus bar is parallel to at least one segment of the at least two segments of the second bus bar.

Embodiment 23. The apparatus of embodiment 19, where at least one segment of the at least two segments of the first bus bar is closer to the second side of the active stack than any of the at least two segments of the second bus bar.

Embodiment 24. The apparatus of embodiment 18, where at least one segment of the at least two segments of the first bus bar is closer to the first side of the active stack than any of the at least two segments of the second bus bar, and where at least one segment of the at least two segments of the first bus bar is parallel to at least one segment of the at least two segments of the second bus bar.

Embodiment 25. The apparatus of embodiment 19, where at least one segment of the at least two segments of the first bus bar is closer to the second side of the active stack than any of the at least two segments of the second bus bar.

Embodiment 26. A method of operating an apparatus including: providing an electroactive device. The electroactive device including: a first conductive layer, a second conductive layer and an active stack. The active stack including: an anodic electrochemical layer between the first conductive layer and the second conductive layer and a cathodic electrochemical layer between the first conductive layer and the second conductive layer. The electroactive device can further include a first bus bar electrically coupled to the first conductive layer, and a second bus bar electrically coupled to the second conductive layer, where the active stack, the first bus bar, and the second bus bar are completely between the first conductive layer and the second conductive layer. The method can further include switching the electrochromic device from a first transmission state to a graded transmission state, where switching the electrochromic device can include biasing the first bus bar to a first voltage and biasing the second bus bar to a second voltage different from the first voltage, and maintaining the graded transmission state.

Embodiment 27. The method of embodiment 26, further including a substrate, where the active stack is between the second conductive layer and the substrate.

Embodiment 28. The method of embodiment 27, where the substrate can include a material selected from the group consisting of glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, and any combination thereof.

Embodiment 29. The method of embodiment 26, where the ion-conducting layer can include a material selected from the group consisting of lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, and any combination thereof.

Embodiment 30. The method of embodiment 26, where the cathodic electrochemical layer can include an electrochromic material.

Embodiment 31. The method of embodiment 30, where the electrochromic material can include a material selected from the group consisting of WO₃, V₂O₅, MoO₃, Nb₂O₅, TiO₂, CuO, Ni2O3, NIO, Ir2O3, Cr2O3, Co2O3, Mn2O3, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 32. The method of embodiment 26, where the first conductive layer can include a material selected from the group consisting of indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 33. The method of embodiment 26, where the second conductive layer can include a material selected from the group consisting of indium oxide, indium tin oxide, doped indium oxide, tin oxide, doped tin oxide, zinc oxide, doped zinc oxide, ruthenium oxide, doped ruthenium oxide and any combination thereof.

Embodiment 34. The method of embodiment 26, where the anodic electrochemical layer can include a material selected from the group consisting of an inorganic metal oxide electrochemically active material, such as WO3, V2O5, MoO3, Nb2O5, TiO2, CuO, Ir2O3, Cr2O3, Co2O3, Mn2O3, Ta2O5, ZrO2, HfO2, Sb2O3, a lanthanide-based material with or without lithium, another lithium-based ceramic material, a nickel oxide (NiO, Ni2O3, or combination of the two), and Li, nitrogen, Na, H, or another ion, any halogen, and any combination thereof.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any sub-combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any sub-combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus comprising:
a first conductive layer;
a second conductive layer;
an active stack between the first conductive layer and the second conductive layer, the active stack comprising an electrochromic material;
a first bus bar electrically coupled to the first conductive layer; and
a second bus bar electrically coupled to the second conductive layer, wherein the active stack, the first bus bar, and the second bus bar are completely between the first conductive layer and the second conductive layer.

2. The apparatus of claim 1, wherein the first bus bar and the second bus bar are adjacent to each other on at least one edge of the active stack.

3. The apparatus of claim 1, further comprising a first substrate, wherein the active stack is between the second conductive layer and the first substrate.

4. The apparatus of claim 2, further comprising a second substrate, wherein the first conductive layer and the second conductive layer are between the first substrate and the second substrate.

5. The apparatus of claim 1, wherein the first bus bar comprises one or more segments that are adjacent to the active stack.

6. The apparatus of claim 4, wherein the second bus bar comprises one or more segments that are adjacent to the active stack.

7. The apparatus of claim 5, wherein the first bus bar is closer to an edge of the active stack than the second bus bar.

8. The apparatus of claim 5, wherein the second bus bar is closer to an edge of the active stack than the first bus bar.

9. The apparatus of claim 5, wherein the first bus bar is about equidistant from an edge of the active stack as the second bus bar.

10. The apparatus of claim 5, wherein the one or more segments of the second bus bar are continuous.

11. The apparatus of claim 4, wherein the one or more segments of the first bus bar are continuous.

12. The apparatus of claim 9, wherein the electrochromic material comprises more than one layer and wherein a combined thickness of the electrochromic material is greater than a combined thickness of the first bus bar and the second bus bar.

13. The apparatus of claim 8, wherein the electrochromic material comprises more than one layer and wherein a combined thickness of the electrochromic material is less than a combined thickness of the first bus bar and the second bus bar.

14. An apparatus comprising:
a first conductive layer comprising a first side and a second side, wherein the first side is opposite the second side;
a second conductive layer, a first side and a second side, wherein the first side is opposite the second side, and wherein the first side of the first conductive layer faces the first side of the second conductive layer;
an active stack between the first conductive layer and the second conductive layer, the active stack comprising an electrochromic material;
a first bus bar electrically coupled to the first conductive layer, wherein the first bus bar is adjacent to the first side of the first conductive layer;
a second bus bar electrically coupled to the second conductive layer, wherein the second bus bar is adjacent to the first side of the second conductive layer.

15. The apparatus of claim 14, wherein the second bus bar comprises at least two segments and the first bus bar comprises at least two segments.

16. The apparatus of claim 15, wherein the at least two segments of the second bus bar are continuous.

17. The apparatus of claim 15, wherein the at least two segments of the first bus bar are continuous.

18. The apparatus of claim 16, wherein at least one segment of the at least two segments of the second bus bar is closer to a first side of the active stack than any of the at least two segments of the first bus bar and wherein at least one segment of the at least two segments of the first bus bar is parallel to at least one segment of the at least two segments of the second bus bar.

19. The apparatus of claim 16, wherein at least one segment of the at least two segments of the first bus bar is closer to a second side of the active stack than any of the at least two segments of the second bus bar.

20. A method of operating an apparatus comprising:
providing an electroactive device, the electroactive device comprising:
a first conductive layer;
a second conductive layer;
an active stack between the first conductive layer and the second conductive layer, the active stack comprising:
an anodic electrochemical layer; and
a cathodic electrochemical layer;
a first bus bar electrically coupled to the first conductive layer;
a second bus bar electrically coupled to the second conductive layer, wherein the wherein the active stack, the first bus bar, and the second bus bar are completely between the first conductive layer and the second conductive layer;
switching the electrochromic device from a first transmission state to a graded transmission state, wherein switching the electrochromic device comprises biasing the first bus bar to a first voltage and biasing the second bus bar to a second voltage different from the first voltage; and
maintaining the graded transmission state.
